(19) United States
(12) Patent Application Publication
(10) Pub. No.: US 2016/0078005 A1
(43) Pub. Date: Mar. 17, 2016

(54) ADAPTIVE TABLE RENDERING

(71) Applicant: Google Inc., Mountain View, CA (US)

(72) Inventor: István SOÓS, Sunnyvale, CA (US)

(73) Assignee: Google Inc., Mountain View, CA (US)

(21) Appl. No.: 14/099,868

(22) Filed: Dec. 6, 2013

(51) Int. Cl. G06F 17/21

(52) U.S. Cl. CPC G06F 17/217

(57) ABSTRACT

A system and method is disclosed for adaptive rendering of displayable elements such as rows in a table displayed on a web page. A web page is provided that includes instructions for displaying a large number of displayable elements that cannot be displayed at the same in a single viewport. A predetermined number of the elements are initially rendered and a time period for the rendering is measured. Based on the measured time period, a pagination mode or a scrolling mode is selected to display the displayable elements.

### BACKGROUND

Table rendering in web applications can be slow, especially if a table has many rows and columns. Moreover, the speed at which a table is rendered may vary between web browsers, and depend on other factors such as network traffic conditions, whether Javascript is embedded within the web application or associated with the table, and the speed at which each browser is able to execute the Javascript.

### SUMMARY

The subject technology provides a system and computer-implemented method for rendering tables for display in a webpage. According to one aspect, a computer-implemented method may include providing, for display in a viewport of a computing device, a displayable document comprising instructions for facilitating a display of a plurality of displayable elements that cannot be displayed together at the same time in the viewport, the instructions, when executed by the computing device, perform the operations of rendering a predetermined number of the plurality of displayable elements for display in the viewport, measuring a first time period for rendering the predetermined number of the plurality of displayable elements, and selecting one of multiple predetermined rendering modes for the plurality of displayable elements based on the measured first time period, a pagination mode being selected for paginating the plurality of displayable elements over a plurality of respective documents when the first time period satisfies a first predetermined threshold. Other aspects include corresponding systems, apparatuses, and computer program products for implementation of the computer-implemented method.

In another aspect, computer program product tangibly embodied in a computer-readable storage device comprises instructions that, when executed by a computing device, cause the computing device to provide a displayable document comprising a listing of displayable elements that cannot be displayed together in a single viewport associated with the computing device, render a predetermined number of the plurality of displayable elements within the displayable document, measure a first time period for rendering the predetermined number of the plurality of displayable elements, and select one of multiple predetermined rendering modes for the plurality of displayable elements based on the measured first time period, a pagination mode being selected for paginating the plurality of displayable elements over a plurality of respective documents when the first time period satisfies a first predetermined threshold. Other aspects include corresponding systems, apparatuses, and computer program products for implementation of the machine-readable medium.

In a further aspect, a system may include one or more processors and a memory. The memory may include instructions that, when executed by the one or more processors, cause the one or more processors to facilitate at least the step of providing a web page to a web browser operating on a computing device, the web page comprising instructions for display of a plurality of displayable elements that cannot be displayed together at the same time in a single viewport. The instructions, when executed by the computing device, may perform the operations of rendering a predetermined number of the plurality of displayable elements for display by the web browser, determining a time period for the rendering, selecting a rendering mode for the displayable elements based on the time period, a pagination mode being selected for paginating the displayable elements over a plurality of respective web pages when the time period satisfies a first predetermined threshold, and a scrolling mode being selected for rendering the displayable elements according to a scroll position of the viewport when the time period satisfies a second predetermined threshold, and, while a mode other than the pagination mode is selected, repeating the rendering, determining, and selecting until all of the plurality of displayable elements are rendered.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

A detailed description will be made with reference to the accompanying drawings:

FIG. 1 depicts an example client-server network environment that facilitates adaptive rendering of tables for display in a web page.

FIG. 2 depicts operation of an example process for adaptive rendering of display elements within an example runtime environment on a client device.

FIGS. 3A to 3C depict example processes for adaptive rendering of display elements.

FIG. 4 is a diagram illustrating an example electronic system 400 for use in connection with adaptive rendering of displayable elements in a web page.

### DETAILED DESCRIPTION

The subject technology provides a mechanism for web pages that display large amounts of data elements (e.g., cannot be displayed together at the same time in a viewport of the web browser) to automatically switch between pagination and scrolling based on latency metrics. In one or more implementations, if scrolling to view a large table of data (e.g., a table spanning multiple viewports) is uneven due to a substantial amount of time required to dynamically render the viewed portions of the table then the table may be automatically paginated over several web pages. In this manner, each page may be individually rendered with minimal latency. The subject technology is described with respect to large tables of information displayed on a web page, however, the subject technology may also be applied to other types of data elements displayed on web pages, including, for example, listing a large number of pictures or graphics or combination of pictures, graphics, and/or table data.

According to various implementations, code is embedded in a web page together with a large table of data to facilitate rendering of the table in a viewport of a web browser. The code, when executed by a computing device, incrementally renders a predetermined number of rows (e.g., 20) of the table at a time, and dynamically measures a time period for each rendering of the predetermined number of rows. The time period may be indicative of the number of frames-per-second the web browser is capable of displaying while a user is scrolling through the table. Based on the measured time period, one of three rendering modes (e.g., modes of display) for the table may be selected. In an initial mode, the table may be progressively rendered by incrementally rendering blocks of rows, while checking the time period for each rendering.

In each rendering step, the subject technology may measure the rendering and/or the total-time-to-update latency, and if that total latency is below a given threshold then the environment may be considered fast, and the table rendered using infinite scrolling technique. If a measured time period for one or more initial rendering iterations is determined to satisfy a first predetermined threshold (e.g., the time period is less than 50 ms) then the rendering of the table may be switched to an infinite scrolling mode in which the table is rendered according to a scroll position associated with a current viewport of the web browser. For example, if the system of the subject technology determines that the browser was able to render and display an initial number of rows of a table within 50 milliseconds then the system may switch further rendering of the table under the infinite scrolling mode regardless of further rendering times. When operating in the infinite scrolling mode, the table may be rendered by the browser in a manner such that rows in and below the viewport may be rendered (e.g., a block of rows at a time) for display by the browser, while previously displayed rows above the viewport are removed.

The subject technology may monitor rendering time periods for newly added rows or blocks of rows, and at a given cutoff row number (e.g., 50, 100, 200) no more rows are added, but instead the display switched to a pagination mode. In one or more implementations, the display of the table is switched to the pagination mode if the measured time period (e.g., for a rendering of an initial number of rows) fails to meet a second predetermined threshold (e.g., the time period is greater than 50 milliseconds). In pagination mode, a number of the rows may be displayed on each of a plurality of web pages, and controls placed on each page (e.g., at the bottom of the page) for navigation between the pages.

In one or more implementations, the number of rows (and/or other displayable elements) in a rendered block of rows may be dynamically adjusted depending on the time period for rendering a prior block. For example, one or more sub-thresholds may be implemented within a mode, or between thresholds for entering modes (e.g., pagination and infinite scrolling). For example, while in scrolling mode the number of rows to be rendered in a subsequent rendering may be determined by comparing the time period of the prior rendering to the sub-thresholds. The number of rows rendered in each rendered block may be adjusted up (e.g., to 50 rows at a time) if the time period is lower (e.g., 10 ms) and adjusted down (e.g., to 10 rows at a time) if the time period is higher (e.g., 40 ms).

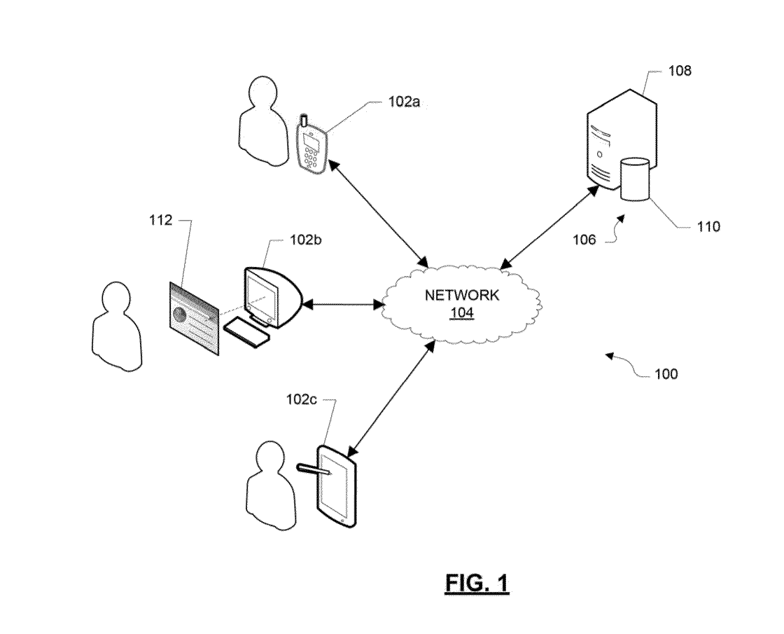

FIG. 1 depicts an example client-server network environment that facilitates adaptive rendering of tables for display in a web page in accordance with one or more implementations of the subject technology. A network environment 100 includes a number of client devices 102a-c communicably connected to one or more servers 106 by a network 104. Communication between client devices 102a-c and server 106 (including, e.g., processing device 108 and a data store 510), may be facilitated through network 104, for example, through the various communication protocols (e.g., HTTP, XMPP).

In various implementations, client devices 102a-c can be any computing device capable of communicating over a communication network, including, for example, laptop or desktop computers, portable computing devices, smartphones, PDAs, portable media players, tablet computers, or other appropriate computing devices. In the example of FIG. 1, three electronic devices are depicted, including a smartphone, a desktop computer, and a PDA. Client devices 102a-c may be configured to access data from other storage media, such as memory cards or disk drives as may be appropriate in the case of downloaded services. Client devices 102a-c may include standard hardware computing components such as network and media interfaces, non-transitory computer-readable storage (memory), and processors for executing instructions that may be stored in memory.

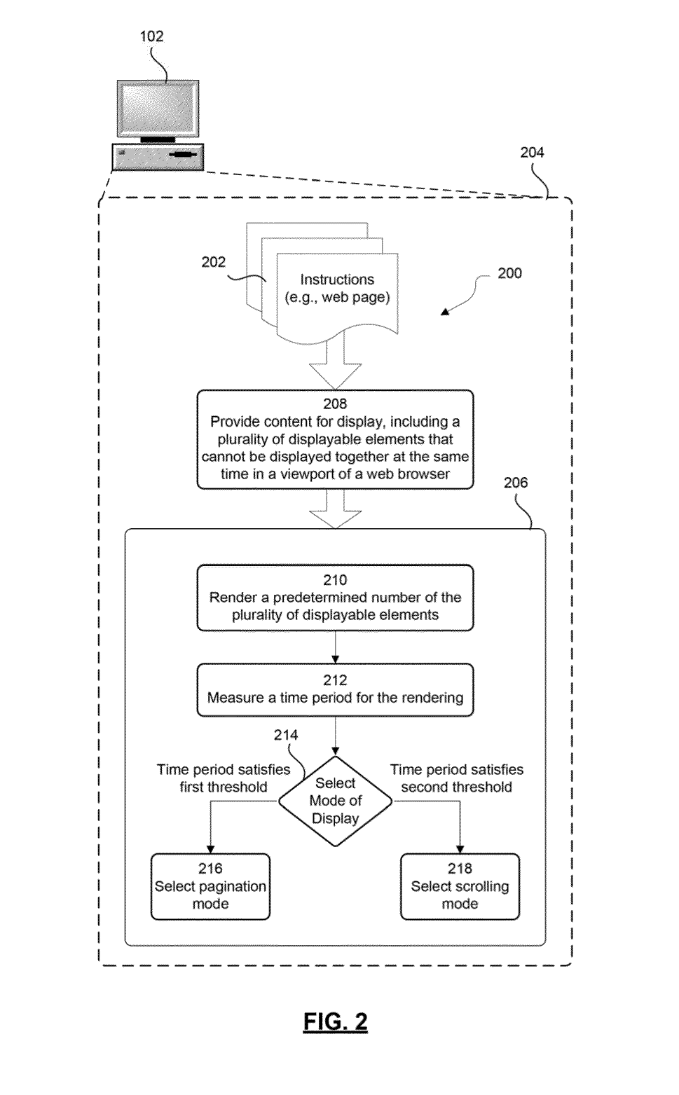

In some implementations, server 106 includes one or more processing devices 108 and a data store 110. Processing device 108 executes computer instructions stored in data store 110, for example, to provide one or more user interfaces 112 (e.g., one or more web pages) to a web browser or other web-enabled application operating on client devices 102. In one or more implementations, server 106 provides, for display in a web browser operating on a client device 102a-c, one or more web pages comprising a plurality of displayable elements that cannot be displayed together at the same time in a viewport of the web browser. For example, a web page may include a large data table, including a large number of rows (and/or columns) of data. As will be described further, server 106 may provide one or more web pages comprising code embedded therein that, when executed by client device, perform various operations, including measuring how long it takes for the web browser to render a predetermined number of table rows, and then select one of multiple predetermined modes of display for displaying the table on user interface 112 based on the measured time. In one or more implementations, Server 106 may implement or facilitate implementation of the various blocks described by FIG. 2.

Server 106 may be a single computing device such as a computer server. In some implementations, server 106 may represent more than one computing device working together to perform the actions of a server computer (e.g., cloud computing). Server 106 may be coupled with various remote databases or storage services. Accordingly, it should be understood that the functions performed by server 106 may be performed within a single server, or across multiple servers. Any of the aforementioned servers (or an integrated server) may take on certain client-side, cache, or proxy server characteristics. These characteristics may depend on the particular network placement of the server or certain configurations of the server.

Network 104 can be a public communication network (e.g., the Internet, cellular data network, dialup modems over a telephone network) or a private communications network (e.g., private LAN, leased lines). The network 108 can include, for example, any one or more of a personal area network (PAN), a local area network (LAN), a campus area network (CAN), a metropolitan area network (MAN), a wide area network (WAN), a broadband network (BBN), the Internet, and the like. Further, network 104 can include, but is not limited to, any one or more of the following network topologies, including a bus network, a star network, a ring network, a mesh network, a star-bus network, tree or hierarchical network, and the like.

FIG. 2 depicts operation of an example process 200 for adaptive rendering of display elements within an example runtime environment on a client device 102 in accordance with one or more implementations. For explanatory purposes, example process 200 is described herein with reference to components of server 106 and client device 102b; however, example process 200 is not so limited. Example process 200 may be performed by a microprocessor and/or other internal components and circuitry of any client device 102a-c. Similarly, a non-transitory machine-readable medium may include machine-executable instructions (e.g., software) thereon that, when executed by any client device 102a-c perform the various blocks of process 200. Further for explanatory purposes, one or more blocks of example process 200 are described herein as occurring in serial, or linearly. However, multiple blocks of example process 200 may occur in parallel. In addition, the blocks of example process 200 need not be performed in the order shown and/or one or more of the blocks of example process 200 need not be performed.

In example process 200, executable instructions 202 are loaded into a runtime environment 204 during operation of client device 102b, compiled, and then executed. In various implementations, runtime environment 204 may include an operating system for client device 102 which provides operation of a web browser 206. Executable instructions 202 may be code for display of one or more web pages in a web browser environment 206 (e.g., HTML and/or scripting code), and is loaded into runtime environment 204 when downloaded from server 106 for the purpose of display within web browser environment 206.

A web page displayed in connection with instructions 202 provide content for display in web browser environment 206 (208), including displayable elements that cannot be displayed together at the same time in a viewport of client device 102b. The displayable elements may be, for example, a large number of rows of a data table (e.g., over a hundred, a thousand, or more), with each row including one or more columns of data. Additionally or in the alternative, the displayable elements may be or include a listing of a large number of pictures or graphics or combination of pictures, graphics, and/or table data. Without implementation of the subject technology, the displayable elements may be large enough to span numerous viewports, and consume a majority of display processing for rendering even though only a small subset of the elements may be viewed in the viewport at any one time. In one or more implementations, each displayable element is a table row that includes an activity or event of a social network stream.

In the depicted example, web browser environment 206 may execute certain portions of instructions 202 at runtime. For example, web browser environment 206 may execute one or more portions of JavaScript or other scripting language embedded in the web page generated by instructions 202. The scripting language functions to provide other features of example process 200, including the facilitation of rendering the displayable elements within web browser environment 206 for display to a user.

In this regard, a predetermined number of the displayable elements are initially rendered (210), and a time period for the rendering measured (212). The time period may be measured by first determining a start time, instructing web browser environment 206 to render the predetermined number of displayable elements, determining an end time for the rendering, and then computing the difference between the start and end times. Based on the measured time period, one or multiple predetermined modes of display for the displayable elements is selected (214). The depicted example includes selecting between a pagination mode (216) and a scrolling mode (218), however other modes may be selected. For example, web browser environment 206 may be instructed to continue rendering the displayable elements iteratively, with each iteration rendering the predetermined number of elements. Each iteration may be measured, and either the pagination mode or scrolling mode selected if the measured time period satisfies one or more predetermined thresholds.

The pagination mode paginates the plurality of displayable elements over multiple respective web pages. Each page may have one or more controls (e.g., hyperlinks) for navigating forward or backward through the paginated pages. The pagination mode may be selected when the measured time period for rendering the predetermined number of the displayable elements satisfies a first predetermined threshold. For example, 100 rows of a table may be rendered, and, if the 100 rows cannot be rendered in 50 milliseconds or less then the table may be broken up into multiple portions that may be rendered over multiple web pages, with each web page rendering a set of rows. In some aspects, the size of each set of displayable elements (e.g., rows and/or pictures or graphics) displayed on each paginated page may be based on the measured time period for rendering the predetermined number of the displayable elements. In some aspects, the size may be based on a rendering time for a set displayed on a paginated page. For example, a second time period may be measured for rendering a respective set of the displayable elements on a paginated page, and the size of each subsequently rendered set adjusted based on the measured second time period.

The scrolling mode renders the displayable elements for display according to a scroll position of the viewport. In one or more implementations, the scrolling mode implements an infinite-scrolling technique in which a conceptually infinite amount of information may be scrolled seemingly effortlessly (without excessive rendering delays). The scrolling mode may be used, for example, to scroll through a social feed of a social network that includes information that is dynamically pulled in from an endless number of users. In the scrolling mode, web browser environment 206 is instructed by instructions 202 to render a respective set of the displayable elements for display in or below the viewport, while removing previously displayed elements above the viewport.

The scrolling mode may be selected when the measured time period for rendering the predetermined number of the displayable elements satisfies a second predetermined threshold. For example, 100 rows of a table may be rendered, and, if the 100 rows can be rendered in less than 50 milliseconds then web browser environment 206 may be instructed to begin infinite-scrolling. In one or more implementations, the first and second predetermined thresholds may be based on the same length of time (e.g., 50 milliseconds). In one or more implementations, the first predetermined threshold may be different (e.g., 100 milliseconds or more) than the second predetermined threshold (e.g., 25 milliseconds or less). In some aspects, the size of each set of displayable elements (e.g., rows and/or pictures or graphics) to be rendered as the user scrolls may be based on the measured time period for rendering the predetermined number of the displayable elements. In some aspects, the size of a first set of elements to be rendered may be based on a rendering time of the first set, and a size of a subsequent set of displayable elements to be rendered may be adjusted based on the measured rendering time of the first set.

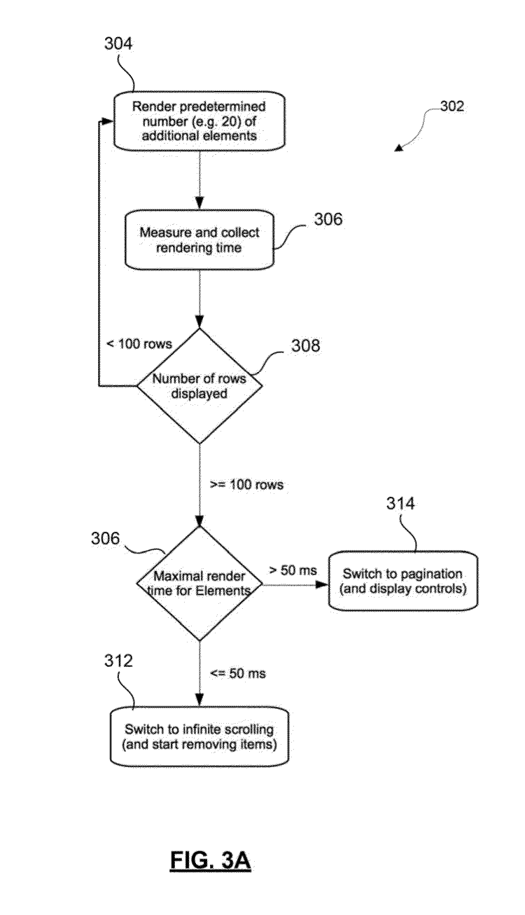

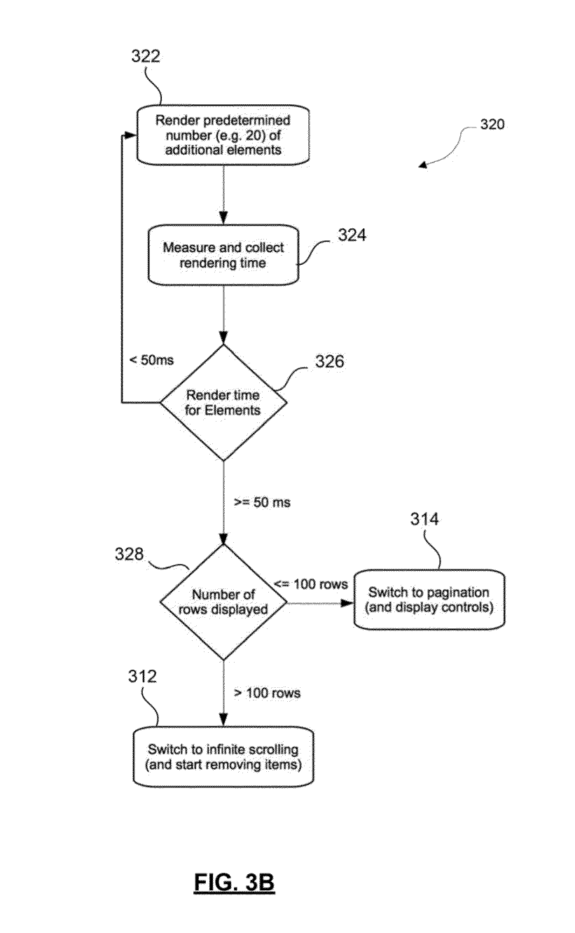

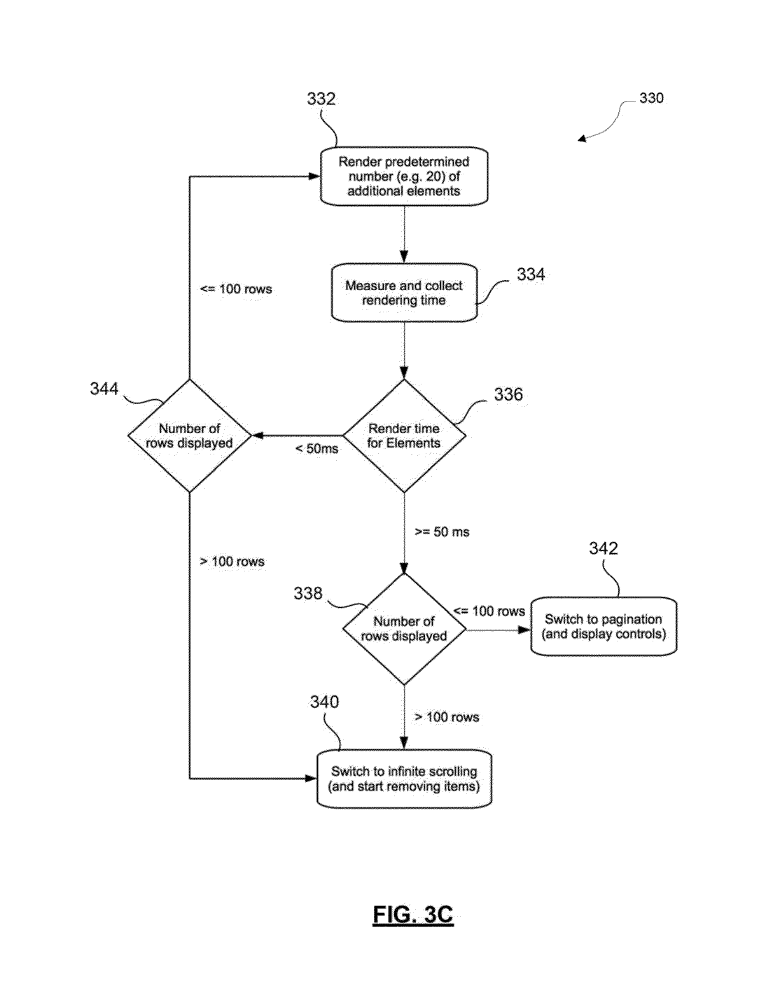

FIGS. 3A to 3C depict example processes for adaptive rendering of display elements in accordance with one or more implementations. For explanatory purposes, the example process of FIGS. 3A to 3C are described herein with reference to components of server 106 and client device 102b; however, the example processes are not so limited. The example process of FIGS. 3A to 3C may be performed by a microprocessor and/or other internal components and circuitry of any client device 102a-c. Similarly, a non-transitory machine-readable medium may include machine-executable instructions (e.g., software) thereon that, when executed by any client device 102a-c perform the various blocks of the processes. Further for explanatory purposes, one or more blocks of the example process of FIGS. 3A to 3C are described herein as occurring in serial, or linearly. However, multiple blocks of the example processes may occur in parallel. In addition, the blocks of the example processes of FIGS. 3A to 3C need not be performed in the order shown and/or one or more of the blocks of the example processes need not be performed.

FIG. 3A is a flowchart depicting a first example process 302 for adaptive rendering of display elements in a web page in accordance with one or more implementations. As described previously, the display elements may be rows of a large table displayed by the web page, or a listing of a large number of pictures or graphics or combination of pictures, graphics, and/or table data. The table or listing may be dynamically generated, for example, as a user scrolls to view the table or listing. In the depicted example, web browser environment 206 iteratively renders a first predetermined number (e.g., 20) of displayable elements at a time (304). For example, scripting language within the web page may instruct the web browser (e.g., via APIs) as to how many rows (or other elements) should be rendered in each iteration. After the rendering for each iteration, web browser environment 206 measures and temporarily stores the total number of elements rendered so far and the total time period that has elapsed since initiating the first iteration (306). The scripting language may generate an array of variables for collecting rendering times and/or the number of elements rendered so far. It is not required that the current viewport in which the table or listing is displayed be able to view the first predetermined number of displayable elements in a single viewing or without scrolling.

After each iteration, web browser environment 206 performs a first check to determine if the second predetermined number of rendered elements is reached (308). If the predetermined number of elements has not been rendered then the iterative process continues. If the predetermined number of elements has been rendered then a second check is performed to determine if the rendering time period for elements rendered so far has satisfied one or more predetermined thresholds (310). For example, the array of variables may be accessed and the values therein retrieved to determine the rendering time period. In some aspects, values stored for each iteration may be summed. In some aspects, the array may maintain a running total which may be retrieved by web browser environment 206 when the second check is to be performed. If the rendering time period satisfies a first threshold (e.g., less than or equal to 50 milliseconds) then web browser environment 206 switches to a scrolling mode (e.g., infinite scrolling) (312), in which the displayable elements are rendered according to a scroll position of the viewport. If the rendering time satisfies a second threshold (e.g., greater than 50 milliseconds) then web browser environment 206 switches to a pagination mode for rendering of the displayable elements (314).

In the depicted example, if the rendering time period for 100 rows is less than or equal to 50 milliseconds then web browser environment 206 switches the display of the table to the scrolling mode. If the rendering time period for 100 rows is greater than 50 milliseconds then web browser environment 206 switches the display of the table to the pagination mode. Accordingly, the rows rendered so far (e.g., 100) may be displayed on a first page, with the remaining elements paginated in sets, each of a predetermined size, or a size determined by the rendering time period. In one or more implementations, each set may be a different size depending on rendering times for each paginated set. For example, if the rendering time period for a second paginated set of elements to be displayed on a second paginated web page is less then or over a predetermined threshold then further sets of paginated pages may be increased or reduced in size, respectively in accordance with the rendering time period.

FIG. 3B is a flowchart depicting a second example process 320 for adaptive rendering of display elements in a web page in accordance with one or more implementations. Web browser environment 206 iteratively renders a first predetermined number (e.g., 20) of displayable elements at a time (322). After the rendering for each iteration, web browser environment 206 measures and temporarily stores the total number of elements rendered so far and the total time period that has elapsed since initiating the first iteration (324). As described previously, these values may be stored in an array or other property in memory.

After each iteration, web browser environment 206 then performs a first check to determine if a predetermined rendering time period has been satisfied (326). For example, web browser environment 206 may determine if the total time period is greater than or equal to 50 milliseconds. If the predetermined rendering time period has not been satisfied then the iterative process continues. If the predetermined rendering time period has been satisfied then a second check is performed to determine how many displayable elements were rendered and displayed so far (e.g., within the rendering time period) (328). If the number of displayable elements rendered so far satisfies a first threshold (e.g., more than 100 rows) then web browser environment 206 uses a scrolling mode (e.g., infinite scrolling) to render the displayable elements of the web page (312). If the number of displayable elements rendered so far satisfies a second threshold (e.g., less than or equal to 100 rows) then web browser environment 206 switches to pagination for rendering of the displayable elements (314).

FIG. 3C is a flowchart depicting a third example process 330 for adaptive rendering of display elements in a web page in accordance with one or more implementations. Web browser environment 206 iteratively renders a first predetermined number (e.g., 20) of displayable elements at a time (332). After the rendering for each iteration, web browser environment 206 measures and temporarily stores the total number of elements rendered so far and the total time period that has elapsed since initiating the first iteration (334). As described previously, these values may be stored in an array or other property in memory.

After each iteration, web browser environment 206 then performs a first check to determine if a predetermined rendering time period has been satisfied (336). For example, web browser environment 206 may determine if the total time period is greater than or equal to 50 milliseconds. If the predetermined rendering time period has been satisfied then a second check is performed to determine how many displayable elements were rendered and displayed so far (e.g., within the rendering time period) (338). If the number of displayable elements rendered so far satisfies a first threshold (e.g., more than 100 rows) then web browser environment 206 switches to a scrolling mode (e.g., infinite scrolling) to render the displayable elements of the web page (340). If the number of displayable elements rendered so far satisfies a second threshold (e.g., less than or equal to 100 rows) then web browser environment 206 switches to pagination for rendering of the displayable elements (342).

With further reference to FIG. 3C, if the predetermined rendering time period has not been satisfied then a third check is performed to determine if a predetermined number of rendered elements is reached (344). For example, web browser environment 206 may determine whether 100 rows have been rendered and displayed within the predetermined rendering time period (e.g., within 50 milliseconds). If the predetermined number of elements has not been rendered then the iterative process continues. If the predetermined number of elements has been rendered then web browser environment 206 switches to a scrolling mode (e.g., infinite scrolling) to render the displayable elements of the web page (340).

Many of the above-described example processes 200, 302, 320, and 330, and related features and applications, may be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

The term “software” is meant to include, where appropriate, firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

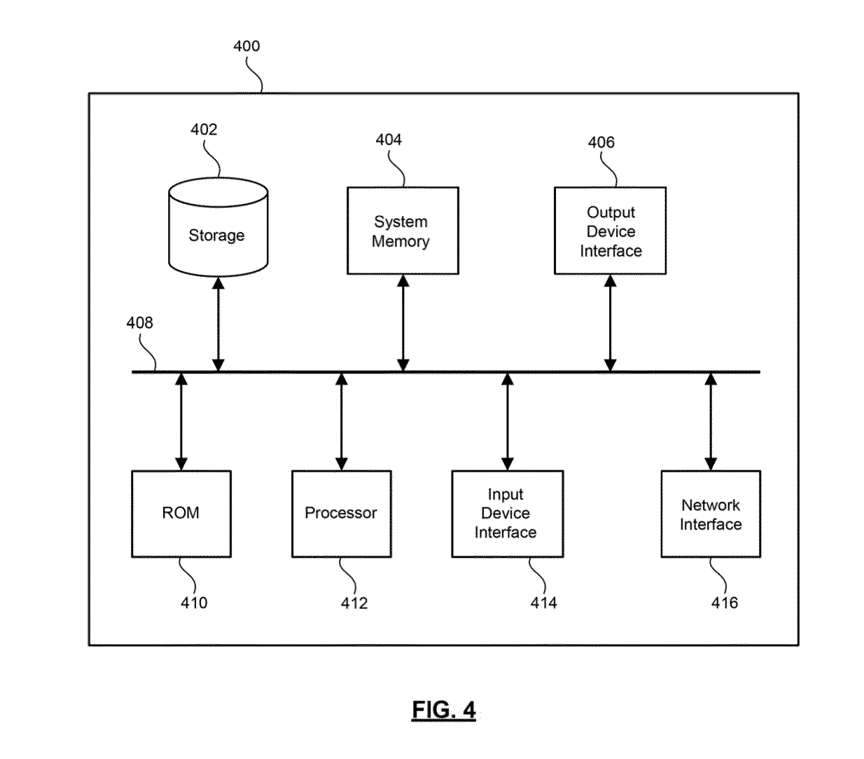

FIG. 4 is a diagram illustrating an example electronic system 400 for use in connection with adaptive rendering of displayable elements in a web page, according to one or more aspects of the subject technology. Electronic system 400 may be a computing device for execution of software associated with the operation of one or more portions or steps of process 200, 302, 320, or 330. In various implementations, electronic system 400 may be representative of a server, computer, phone, PDA, laptop, tablet computer, touch screen or television with one or more processors embedded therein or coupled thereto, or any other sort of electronic device.

Electronic system 400 may include various types of computer readable media and interfaces for various other types of computer readable media. In the depicted example, electronic system 400 includes a bus 408, processing unit(s) 412, a system memory 404, a read-only memory (ROM) 410, a permanent storage device 402, an input device interface 414, an output device interface 406, and a network interface 416. In some implementations, electronic system 400 may include or be integrated with other computing devices or circuitry for operation of the various components and processes previously described.

Bus 408 collectively represents all system, peripheral, and chipset buses that communicatively connect the numerous internal devices of electronic system 400. For instance, bus 408 communicatively connects processing unit(s) 412 with ROM 410, system memory 404, and permanent storage device 402.

From these various memory units, processing unit(s) 412 retrieves instructions to execute and data to process in order to execute the processes of the subject disclosure. The processing unit(s) can be a single processor or a multi-core processor in different implementations.

ROM 410 stores static data and instructions that are needed by processing unit(s) 412 and other modules of the electronic system. Permanent storage device 402, on the other hand, is a read-and-write memory device. This device is a non-volatile memory unit that stores instructions and data even when electronic system 400 is off. Some implementations of the subject disclosure use a mass-storage device (such as a magnetic or optical disk and its corresponding disk drive) as permanent storage device 402.

Other implementations use a removable storage device (such as a floppy disk, flash drive, and its corresponding disk drive) as permanent storage device 402. Like permanent storage device 402, system memory 404 is a read-and-write memory device. However, unlike storage device 402, system memory 404 is a volatile read-and-write memory, such a random access memory. System memory 404 stores some of the instructions and data that the processor needs at runtime. In some implementations, the processes of the subject disclosure are stored in system memory 404, permanent storage device 402, and/or ROM 410. From these various memory units, processing unit(s) 412 retrieves instructions to execute and data to process in order to execute the processes of some implementations.

Bus 408 also connects to input and output device interfaces 414 and 406. Input device interface 414 enables the user to communicate information and select commands to the electronic system. Input devices used with input device interface 414 include, for example, alphanumeric keyboards and pointing devices (also called “cursor control devices”). Output device interfaces 406 enables, for example, the display of images generated by the electronic system 400. Output devices used with output device interface 406 include, for example, printers and display devices, such as cathode ray tubes (CRT) or liquid crystal displays (LCD). Some implementations include devices such as a touchscreen that functions as both input and output devices.

Finally, as shown in FIG. 4, bus 408 also couples electronic system 400 to a network (not shown) through a network interface 416. In this manner, the computer can be a part of a network of computers (such as a local area network (“LAN”), a wide area network (“WAN”), or an Intranet, or a network of networks, such as the Internet. Any or all components of electronic system 400 can be used in conjunction with the subject disclosure.

These functions described above can be implemented in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that the specific order or hierarchy of steps in the processes disclosed is an illustration of example approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

The term website, as used herein, may include any aspect of a website, including one or more web pages, one or more servers used to host or store web related content, and the like. Accordingly, the term website may be used interchangeably with the terms web page and server. The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a “configuration” may refer to one or more configurations and vice versa.

The word “example” is used herein to mean “serving as an example or illustration.” Any aspect or design described herein as “example” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. A computer-implemented method, comprising:
providing, for display in a viewport of a computing device, a displayable document comprising instructions for facilitating a display of a plurality of displayable elements that cannot be displayed together at the same time in the viewport, the instructions, when executed by the computing device, perform the operations of:
rendering a predetermined number of the plurality of displayable elements for display in the viewport;
measuring a first time period for rendering the predetermined number of the plurality of displayable elements; and
selecting one of multiple predetermined rendering modes for the plurality of displayable elements based on the measured first time period, a pagination mode being selected for paginating the plurality of displayable elements over a plurality of respective documents when the first time period satisfies a first predetermined threshold.

2. The computer-implemented method of claim 1, wherein the instructions, when executed, further perform the operations of:
when the first time period satisfies a second predetermined threshold, selecting a scrolling mode in which the plurality of displayable elements are rendered according to a scroll position of the viewport.

3. The computer-implemented method of claim 2, wherein the instructions, when executed, further perform the operations of:
selecting the scrolling mode based on the first time period; and
rendering a respective set of the displayable elements for display in or below the viewport and removing previously displayed elements above the viewport.

4. The computer-implemented method of claim 3, wherein the instructions, when executed, further perform the operations of:
measuring a second time period for rendering a first set of the displayable elements in the viewport;
adjusting a size of a second set of the displayable elements based on the measured second time period of the first set; and
rendering the second set for display in the viewport.

5. The computer-implemented method of claim 2, wherein satisfying the first predetermined threshold comprises the first time period being more than a predetermined length of time, and wherein satisfying the second predetermined threshold comprises the first time period being less than the predetermined length of time.

6. The computer-implemented method of claim 5, wherein the predetermined length of time is between 25 and 100 milliseconds.

7. The computer-implemented method of claim 1, wherein the plurality of displayable elements comprises a plurality of table rows of one or more tables, and
wherein rendering the predetermined number of the plurality of displayable elements comprises rendering the predetermined number of table rows of the one or more tables.

8. The computer-implemented method of claim 1, wherein the instructions, when executed, further perform the operations of:
while a rendering mode other than the pagination mode is selected, repeating the rendering, measuring, and selecting until all of the plurality of displayable elements are rendered.

9. The computer-implemented method of claim 1, wherein the instructions, when executed, further perform the operations of:
selecting the pagination mode based on the first time period, each respective document displaying a respective set of the displayable elements;
measuring a second time period for rendering a respective set of the displayable elements; and
adjusting a size of each respective set based on the measured second time period.

10. The computer-implemented method of claim 1, wherein the displayable document is a web page, and the viewport is provided by a web browser operating on the computing device, and wherein the instructions are downloaded to the computing device from a remote server, the instructions, when executed by the computing device, generating a display of the web page.

11. A computer program product tangibly embodied in a computer-readable storage device and comprising instructions that, when executed by a computing device, cause the computing device to:
provide a displayable document comprising a listing of displayable elements that cannot be displayed together in a single viewport associated with the computing device;
render a predetermined number of the plurality of displayable elements within the displayable document;
measure a first time period for rendering the predetermined number of the plurality of displayable elements; and
select one of multiple predetermined rendering modes for the plurality of displayable elements based on the measured first time period, a pagination mode being selected for paginating the plurality of displayable elements over a plurality of respective documents when the first time period satisfies a first predetermined threshold.

12. The computer program product of claim 11, wherein the instructions are downloaded to the computing device from a remote server, the instructions, when executed by the computing device, generating a display of the displayable document.

13. The computer program product of claim 12, wherein the displayable document is a web page, and the viewport is provided by a web browser operating on the computing device.

14. The computer program product of claim 11, wherein the instructions, when executed by the computing device, further causing the computing device to:
determine that the first time period satisfies a second predetermined threshold;
select a scrolling mode based on the determining;
rendering a respective set of the displayable elements according to a scroll position of the viewport, the respective set being rendered in or below the viewport;
removing previously displayed elements above the viewport.

15. The computer program product of claim 14, wherein the instructions, when executed by the computing device, further causing the computing device to:
measure a second time period for rendering a first set of the displayable elements in the viewport;
adjust a size of a second set of the displayable elements based on the measured second time period of the first set; and
render the second set for display in the viewport.

16. The computer program product of claim 11, wherein each displayable element is a row of a data table.

17. The computer program product of claim 11, wherein the instructions, when executed by the computing device, further causing the computing device to:
while a rendering mode other than the pagination mode is selected, repeating the rendering, measuring, and selecting until all of the plurality of displayable elements are rendered.

18. The computer program product of claim 11, wherein the instructions, when executed by the computing device, further causing the computing device to:
select the pagination mode based on the first time period, each respective document displaying a respective set of the displayable elements;
measure a second time period for rendering a respective set of the displayable elements; and
adjust a size of each respective set based on the measured second time period.

19. The computer program product of claim 1, wherein the instructions, when executed by the computing device, further causing the computing device to:
render the predetermined number of the plurality of displayable elements in multiple iterations, each iteration comprising a set of elements being rendered.

20. A system, comprising:
one or more processors; and
a memory including instructions that, when executed by the one or more processors, cause the one or more processors to facilitate the step of:
providing a web page to a web browser operating on a computing device, the web page comprising instructions for display of a plurality of displayable elements that cannot be displayed together at the same time in a single viewport, the instructions, when executed by the computing device, perform the operations of:
rendering a predetermined number of the plurality of displayable elements for display by the web browser;
determining a time period for the rendering;
selecting a rendering mode for the displayable elements based on the time period, a pagination mode being selected for paginating the displayable elements over a plurality of respective web pages when the time period satisfies a first predetermined threshold, and a scrolling mode being selected for rendering the displayable elements according to a scroll position of the viewport when the time period satisfies a second predetermined threshold; and
while a mode other than the pagination mode is selected, repeating the rendering, determining, and selecting until all of the plurality of displayable elements are rendered.
